(19) United States
(12) Patent Application Publication
(10) Pub. No.: US 2009/0147856 A1
(43) Pub. Date: Jun. 11, 2009

(54) VARIABLE COLOR FORMAT BASED VIDEO ENCODING AND DECODING METHODS AND APPARATUSES

(75) Inventors: BYUNG-CHEOL SONG, Suwon-si (KR); Yun-gu Lee, Yongin-si (KR); Nak-hoon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/201,261

(22) Filed: Aug. 29, 2008

(30) Foreign Application Priority Data
Dec. 5, 2007 (KR) 10-2007-0125770

(51) Int. Cl. H04N 7/12

(52) U.S. Cl. 375/240.23; 375/E07.076

(57) ABSTRACT

Provided are video encoding and decoding methods and apparatuses for encoding a video by variably selecting one from two or more difference color formats. Accordingly, by using at least one of channel state information and a result of encoding a video in a predetermined encoding unit encoded in advance, whether or not to convert a video in a current encoding unit of an input RGB (red, green, blue) color format into a YCbCr color format is adaptively determined to perform encoding. Therefore, a video with uniform quality corresponding to a channel environment having a variable bit-rate can be provided.

### CROSS-REFERENCE TO RELATED PATENT APPLICATION

This application claims the benefit of Korean Patent Application No. 10-2007-0125770, filed on Dec. 5, 2007, in the Korean Intellectual Property Office, the disclosure of which is incorporated herein in its entirety by reference.

### BACKGROUND OF THE INVENTION

1. Field of the Invention

The present invention relates to a video encoding method and apparatus and a video decoding method and apparatus, and more particularly, to a video encoding method and apparatus and a video decoding method and apparatus capable of variably selecting an RGB (red, green, blue) format or a YCbCr format by using channel information or encoding information to perform encoding.

2. Description of the Related Art

In general, an initial image is taken in an RGB (red, blue, green) color format. In order to compress a video, a YCbCr color format using relatively less data than that of the RGB color format has been used. By converting an image input in the RGB color format into the YCbCr color format, data is reduced, and the converted image can have a smaller bandwidth as compared with the RGB color format. In addition, a human eye is more sensitive to luminance components than chrominance components, so more bandwidth is allocated to the luminance components without reducing image quality greatly. Accordingly, the YCbCr color format is used to compress and restore the video. In order to improve compression efficiency, a YUV (or YCbCr) 4:2:0 video generated by sampling U (or Cb) and V (or Cr) components of a YUV (or YCbCr) video by 1/4 is used. For example, for an MPEG-2 main profile, video is compressed and restored using YCbCr 4:2:0.

However, as telecommunication technologies have been developed, communication environments with wider bandwidths have been provided. In addition, as processing performances of video processing apparatuses have been improved, a large amount of video data can be rapidly processed. Therefore, the demand for video with high quality has been increased. As described above, in the conventional video processing apparatuses, the input video is converted (i.e., transformed) into the YCbCr color format based on the RGB color format so as to be processed. But, in the format converting process, color deterioration may occur, and the video based on the YCbCr color format has relatively degraded video quality as compared with the video based on the RGB color format. Therefore, methods of coding the video in the RGB format without the format converting process have been developed.

FIG. 1 is a view illustrating peak signal-to-noise ratios (PSNRs) of the video based on the RGB format and the video based on the YCbCr with respect to a bit-rate of a channel.

Video coding based on the RGB format may provide good video quality in a high bit-rate environment. However, as the bit-rate decreases, the quality of the video based on the RGB format may be more degraded than the video based on the YCbCr format. Referring to FIG. 1, at a bit-rate less than a predetermined bit-rate a (bits/sec), the PSNR value of the video based on the RGB format is smaller than that of the video based on the YCbCr format. Here, the bit-rate a where positions of the PSNR value of the video based on the RGB format and the PSNR value of the video based on the YCbCr format are reversed is determined according to a communication environment and the performance of the video processing apparatus, so that a specific value of a is not defined. However, in any case, as illustrated in FIG. 1, at a bit rate less than a predetermined bit rate, the PSNR value of the video based on the RGB format is smaller than that of the video of the YCbCr format.

As described above, the video coding method based on the RGB format has the problem of video quality deterioration when a given bit-rate decreases due to bandwidth limitation of wired or wireless channels.

### SUMMARY OF THE INVENTION

The present invention provides a method and apparatus for encoding a video by varying a color format according to a channel state and a method and apparatus for decoding the video.

According to an aspect of the present invention, there is provided a variable color format based video encoding method including: determining whether or not to perform color format conversion converting an input video in a current encoding unit of a first color format into a second color format by using at least one of channel state information and a result of encoding a video in a predetermined encoding unit encoded in advance; when the video in the current encoding unit is determined to be converted into the second color format, converting and outputting the video in the current encoding unit of the first color format into the second color format, and otherwise, outputting the video of the current encoding unit in the first color format as it is; and encoding the output video in the current encoding unit.

According to another aspect of the present invention, there is provided a variable color format based video encoding apparatus including: a color format determiner determining whether or not to perform a color format conversion converting an input video in a current encoding unit of a first color format into a second color format by using at least one of channel state information and a result of encoding a video in a predetermined encoding unit encoded in advance, and outputting a predetermined color format control signal representing whether or not to perform the color format conversion; a color format converter, when the video in the current encoding unit is determined to be converted into the second color format according to the color format control signal, converting and outputting the video in the current encoding unit of the first color format into the second color format, and when the color format control signal does not represent the color format conversion, outputting the video of the current encoding unit in the first color format as it is; and an encoder encoding the output video in the current encoding unit.

According to another aspect of the present invention, there is provided a variable color format based video decoding method including: receiving a video encoded by variably selecting a first color format or a second color format in a predetermined encoding unit; decoding the input video in a predetermined decoding unit corresponding to the encoding unit; determining a color format used to encode the video of the current decoding unit by extracting color format information on the video in the current decoding unit from an input bitstream; and when the current decoding unit is encoded in the first color format, outputting the decoded video of the current decoding unit video as it is, and when the current decoding unit is encoded in the second color format, converting the decoded video of the current decoding unit into the first color format.

According to another aspect of the present invention, there is provided a variable color format based video decoding apparatus including: a decoder receiving a video encoded by variably selecting a first color format or a second color format in a predetermined encoding unit and decoding the input video in a predetermined decoding unit corresponding to the encoding unit; and a color format converter extracting color format information on the video in the current decoding unit from an input bitstream, when the current decoding unit is encoded in the first color format, outputting the decoded video of the current decoding unit as it is, and when the current decoding unit is encoded in the second color format, converting the decoded video of the current decoding unit into the first color format.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating peak signal-to-noise ratios (PSNRs) of a video based on an RGB (red, green, blue) format and a video based on a YCbCr format with respect to a bit-rate of a channel;

FIG. 2 is a block diagram illustrating a video encoding apparatus 200 according to an exemplary embodiment of the present invention;

FIG. 3 is a view illustrating an encoder 250 according to the exemplary embodiment of the present invention shown in FIG. 2;

FIG. 4 is a flowchart illustrating a variable color format based video encoding method according to another exemplary embodiment of the present invention;

FIG. 5 is a block diagram illustrating a variable color format based video decoding apparatus according to another exemplary embodiment of the present invention;

FIG. 6 is a block diagram illustrating a decoder 510 illustrated in FIG. 5; and

FIG. 7 is a flowchart of a variable color format based video decoding method according to another exemplary embodiment of the present invention.

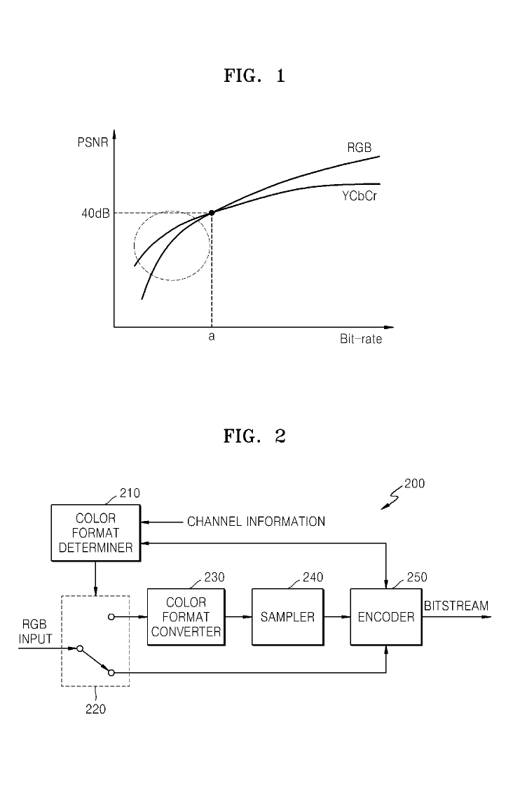

### DETAILED DESCRIPTION OF EXEMPLARY EMBODIMENTS OF THE INVENTION

Hereinafter, exemplary embodiments of the present invention will be described in detail with reference to the attached drawings.

FIG. 2 is a block diagram illustrating a video encoding apparatus 200 according to an embodiment of the present invention.

Referring to FIG. 2, the video encoding apparatus 200 according to the embodiment includes a color format determiner 210, a switch 220, a color format converter 230, a sampler 240, and an encoder 250.

The color format determiner 210 determines whether or not to convert (referred to as transform) an input video in a current encoding unit of a first color format into a second color format, by using at least one or more of channel state information and a result of encoding a video in a previous encoding unit encoded by the encoder 250. For convenience of description, the first color format is an RGB (red, blue, green) color format, and the second color format is a YCbCr color format. However, it will be understood by those of ordinary skill in the art that the first and second color formats are not limited to the aforementioned examples but may be modified in different color formats. In addition, in the description, the encoding unit represents a video unit for determining color format conversion, and examples of the encoding unit may include a sequence, a frame, a slice, and a macroblock.

After determining whether or not to convert the input video in the current encoding unit of the RGB color format into the YCbCr color format, the color format determiner 210 outputs a color format conversion control signal to the switch 220 and the encoder 250. For example, the color format determiner 210 determines whether to encode a current frame in the RGB color format or in the YCbCr color format by using at least one of a state information on a current channel and a result of encoding previous frames encoded by the encoder 250, in units of frame. Here, the state information on the channel may be a bit-rate of the channel. In addition, the result of encoding the previous frames may use quantization parameters of the previous frames generated as a result of encoding the previous frames, a bit-rate, prediction error information, and the like.

When the bit-rate of the channel is used to determine the color format conversion, the color format determiner 210 determines that the channel state is bad when the bit-rate of the current channel is equal to or less than a predetermined first threshold Th1 and determines to encode the video of the current frame in the YCbCr color format that generates relatively less data. In this case, the color format determiner 210 outputs the color format conversion control signal to the switch 220, and the switch 220 then outputs the input current frame video in the RGB color format to the color format converter 230. When the color format determiner 210 determines to encode the input current frame video in the RGB color format into the RGB color format without converting the current frame video into the YCbCr color format, the switch 220 directly outputs the current frame video in the RGB color format to the encoder 250.

When the quantization parameter generated when the previous frame is encoded is used to determine the color format conversion, the color format determiner 210 determines to encode the video of the current frame into the YCbCr color format when the quantization parameter generated when the previous frame is encoded is equal to or more than a predetermined second threshold Th2. Here, as the quantization parameter of the previous encoding unit, which is a reference value used to determine the color format conversion, a quantization parameter generated when a frame encoded before the current frame is encoded, or an average value of quantization parameters generated when a predetermined number of previous frames are encoded may be used. The quantization parameter is determined in consideration of the channel state and an amount of generated bits. When the quantization parameter is greater, the amount of bits generated is relatively smaller, and when the quantization parameter is smaller, the amount of bits generated is relatively larger. Therefore, the quantization parameter can be used as an index for determining the color formation conversion.

When the bit-rate generated when the previous frame is encoded is used to determine the color format conversion, the color format determiner 210 determines to encode the video of the current frame in the YCbCr color format when the bit-rate generated when the previous frame is encoded is equal to or larger than a predetermined third threshold Th3. Here, in addition to the bit-rate generated by a single previous frame, by comparing an average value of the bit-rates generated by a predetermined number of previous frames with the third threshold Th3, the color formation conversion can be determined. Here, when the amount of data generated when the previous frame is encoded exceeds the predetermined third threshold Th3, the video quality may be deteriorated due to transmission delay. Therefore, in order to prevent the deterioration, the video may be converted into the YCbCr color format with a relatively lower amount of generated data.

When the prediction error generated when the previous frame is encoded is used to determine the color format conversion, the color format determiner 210 determines to encode the video of the current frame into the YCbCr color format when the prediction error generated when the previous frame is encoded is equal to or larger than a predetermined fourth threshold Th4. Here, the prediction error represents a difference between the input previous frame video and a predicted pervious frame video and uses a result of encoding the previous frame fed back from the encoder 250.

As described above, when the color format conversion is determined by using the encoding result in the previous encoding unit, the color format determiner 210 outputs the color format conversion control signal to the switch 220 to enable the switch 220 to output the input current frame video in the RGB color format to the color format converter 230 or directly input the current frame video in the RGB color format to the encoder 250.

The color format converter 230 converts the input video in the current encoding unit of the RGB color format into the YCbCr color format. The sampler 240 performs sampling on the video in the current encoding unit of the converted YCbCr color format according to a video format used by the encoder 250. When it is assumed that the input RGB color format has a 4:4:4 sampling pattern, the color format converter 230 outputs a YCbCr color format video having the 4:4:4 sampling pattern, and the sampler 240 performs down-sampling on the input YCbCr color format video having the 4:4:4 sampling pattern according to the video format used by the encoder 250 into a YCbCr color format video having a 4:2:2 sampling pattern or a YCbCr color format video having a 4:2:0 sampling pattern. Here, as is well known by those of ordinary skill in the art, the 4:2:2 sampling pattern or the 4:2:0 sampling pattern represents a ratio of chrominance signals Cb and Cr in vertical and horizontal directions with respect to a luminance signal Y, so that a detailed description thereof is omitted.

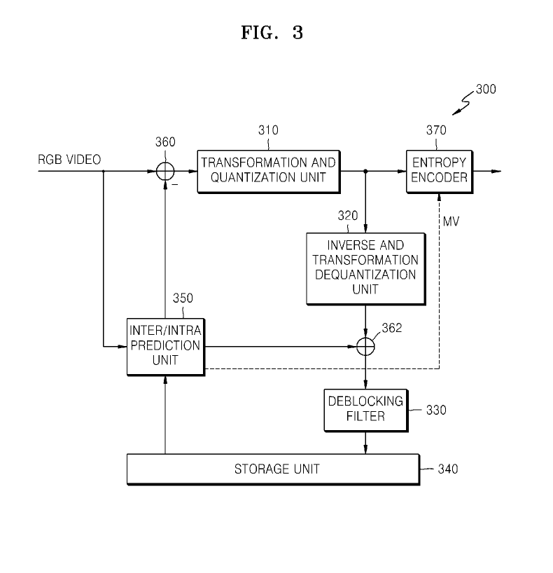

The encoder 250 performs encoding on the video in the current encoding unit converted into the YCbCr color format or the video in the current encoding unit in the RGB color format to output an encoded bitstream. The encoder 250 is described in detail with reference to FIG. 3.

FIG. 3 is a view illustrating the encoder 250 according to the embodiment of the present invention. In FIG. 3, as an example of the encoder 250, an encoding unit according to the H.264 standard is illustrated. However, an encoding unit according to another video compression standard may be applied to the encoder 250.

Referring to FIG. 3, the encoding unit 300 includes a transformation and quantization unit 310, an inverse transformation and dequantization unit 320, a deblocking filter 330, an RGB storage unit 340, an inter/intra prediction unit 350, a first adder 360, a second adder 362, and an entropy encoder 370.

The transformation and quantization unit 310 transforms input video data in order to remove spatial redundancy of the video data. In addition, N×M data that is two-dimensional data including quantized transformation parameter values obtained by quantizing transformation parameter values obtained by performing transformation, by using predetermined quantization parameters, is obtained. An example of the video transform that is used is a discrete cosine transform (DCT).

The inverse transformation and dequantization unit 320 dequantizes the video data quantized by the inverse transformation and quantization unit 310 and performs inverse transform, for example, inverse-DCT on the dequantized video data.

The second adder 362 adds a prediction video output from the inter/intra prediction unit 350 with data restored by the inverse transformation and dequantization unit 320 to generate a restored video.

The deblocking filter 330 performs filtering in order to remove a blocking phenomenon generated by the quantization from the restored video generated by the second adder 362 and outputs the result of the filtering to the RGB storage unit 340. Alternatively, the deblocking filter 330 may be omitted.

The storage unit 340 stores the video data dequantized and inverse transformed by the inverse transformation and dequantization unit 320 or the data filtered by the deblocking filter 330 in units of a frame. As the storage unit 340, a volatile memory device such as a synchronous dynamic random access memory (SDRAM), a double data rate (DDR) SDRAM, a DDR2 SDRAM, a static random access memory (SRAM), and a register may be used. The restored video stored in the storage unit 340 is output after a predetermined time delay and used for inter prediction or intra prediction.

The inter/intra prediction unit 350 includes an intra prediction unit and a motion prediction and compensation unit (not shown).

The intra prediction unit obtains a predictor per block or macroblock for an intra macroblock in a spatial domain and outputs the obtained predictor to the first adder 360.

The motion prediction and compensation unit estimates a motion vector MV per macroblock by using the input video data of the current frame and the video data of the previous frame stored in the storage unit 340. In addition, the motion prediction and compensation unit generates and outputs a motion-compensated prediction region on the basis of the estimated motion vector, for example, a 16×16 region selected by motion estimation, to the first adder 360.

The first adder 360 converts and outputs information on a difference between the original video and the predictor output from the inter/intra prediction unit 350 into a predetermined block unit to the quantization unit 310.

The entropy encoder 370 receives the quantized transformation parameters output from the transformation and quantization unit 310 and information on the motion vectors output from the motion prediction and compensation unit to perform entropy-encoding thereon and outputs a finally obtained encoded bitstream. Here, bit-rate information on the bitstream generated by the entropy encoder 370 is input to the color format determiner 210 so as to be used as a reference value for determining the color formation conversion. In addition, the entropy encoder 370 inserts information on the color format used to encode the video in the current encoding unit into a predetermined region of the bitstream. For example, binary information is inserted into a header region of the bitstream in the current encoding unit. Binary information ‘0’ represents a video encoding unit encoded in the RGB color format, and binary information ‘1’ represents a video encoding unit encoded in the YCbCr color format.

The quantization parameter information used by the transformation and quantization unit 310 is input to the color format determiner 210 so as to be used as a reference value for determining the color format conversion. In addition, a controller that is not shown controls so that the prediction error information that is a difference value between the original video output from the first adder 360 and the predictor is output to the color format determiner 210, and the prediction error information is used as a reference value for determining the color format conversion.

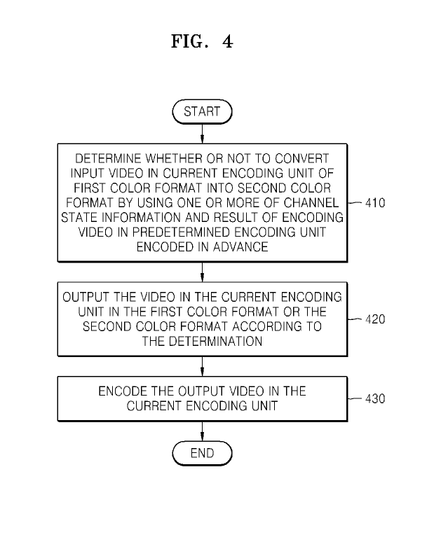

FIG. 4 is a flowchart illustrating a variable color format based video encoding method according to another embodiment of the present invention.

Referring to FIG. 4, in operation 410, by using one or more of channel state information and a result of encoding a video in a predetermined encoding unit encoded in advance, it is determined whether or not to convert an input video in a current encoding unit of a first color format into a second color format. That is, the color formation conversion is determined. As described above, by using the quantization parameter, the bit-rate, and the prediction error information generated when the bit-rate of the channel and the video of the previous frame are encoded, whether or not the input frame video in the RGB color format is converted into a frame video in the YCbCr color format is determined.

In operation 420, when it is determined that the video in the current encoding unit of the first color format is converted into a second color format, the video in the current encoding unit of the first color format is converted into the second color format and output, and when it is determined that the video in the current encoding unit of the first color format needs not to be converted into the second color format, the video in the current encoding unit of the first color format is output in the first color format.

In operation 430, the video in the current encoding unit converted into the second color format or the video in the current encoding unit of the first color format which is output without the color format conversion operation is encoded.

In the description, as the encoding unit, a frame unit is used. However, it will be understood by those of ordinary skill in the art that the encoding unit that is a unit for determining the color format conversion may be, for example, a sequence unit, a frame unit, a slice unit, or a macroblock unit as described above.

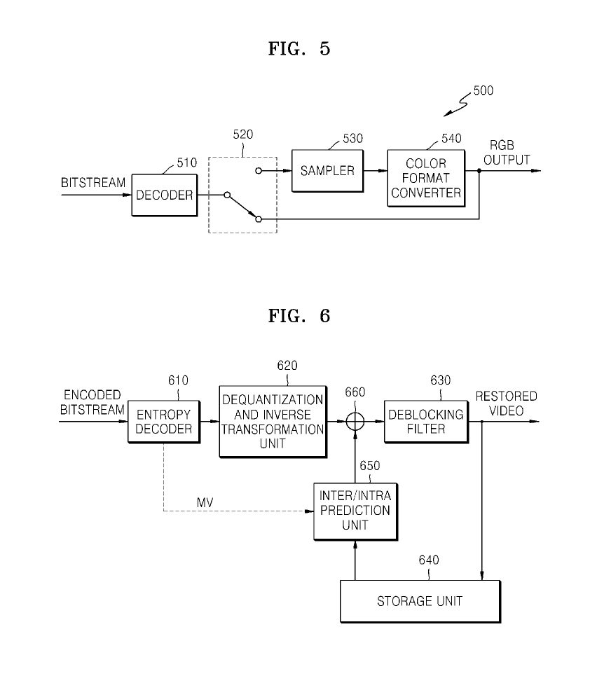

FIG. 5 is a block diagram illustrating a variable color format based video decoding apparatus according to another embodiment of the present invention.

Referring to FIG. 5, the variable color format based video decoding apparatus 500 according to the embodiment includes a decoder 510, a switch 520, a sampler 530, and a color format converter 540.

The decoder 510 decodes and outputs an input bitstream. The decoder 510 is described in detail with reference to FIG. 6.

FIG. 6 is a block diagram illustrating the decoder 510 illustrated in FIG. 5.

The decoder illustrated in FIG. 6 includes an entropy decoder 610, a dequantization and inverse transformation unit 620, a deblocking filter 630, a storage unit 640, an inter/intra prediction unit 650, and an adder 660.

The entropy decoder 610 performs entropy-decoding on the encoded bitstream to extract video data, motion vectors, and color format information used for encoding. The entropy-decoded video data is input to the dequantization and inverse transformation unit 620, and the motion vector information is input to the inter/intra prediction unit 650.

The inverse transformation and dequantization unit 620 performs inverse transformation and dequantization on the video data extracted by the entropy decoder 610.

The deblocking filter 630 performs filtering in order to remove the blocking phenomenon generated by the quantization from the restored video generated by the adder 660 and outputs the result of the filtering to the storage unit 640. Alternatively, the deblocking filter 630 may be omitted.

The storage unit 640 stores the video data dequantized and inverse transformed by the inverse transformation and dequantization unit 620 or the data filtered by the deblocking filter 630 in the frame unit. The restored video stored in the storage unit 640 is output after a predetermined time delay and used for the inter prediction or the intra prediction.

The adder 660 adds the video restored by the inversion and dequantization unit 620 to the predictor output from the inter/intra prediction unit 650 so as to be output.

Returning to FIG. 5, the switch 520 reads the color format information applied to the current decoding unit extracted by the decoder 510. When the video in the current decoding unit is encoded in a first color format, for example, the RGB color format, the switch 520 outputs the decoded video, and when the video in the current decoding unit is encoded in a second color format, for example, in the YCbCr color format, the switch 520 outputs the video decoded in the YCbCr color format to the sampler 530.

The sampler 530 performs up-sampling on the decoded video in the current decoding unit of the YCbCr color format according to the applied video format. When the decoded video in the current decoding unit of the YCbCr color format has the 4:2:2 sampling pattern or the 4:2:0 sampling pattern, the decoded video in the YCbCr color format is up-sampled to a YCbCr color format video having the 4:4:4 sampling pattern.

When the current decoding unit is encoded in the first color format, the color format converter 540 outputs the decoded current decoding unit without the color formation conversion operation, and when the current decoding unit is converted and encoded into the second color format, the color format converter 540 performs the color format conversion on the decoded video in the YCbCr color format having the decoded 4:4:4 sampling pattern into the decoded video in the RGB color format having the 4:4:4 sampling pattern so as to be output to a display apparatus (not shown) or the like.

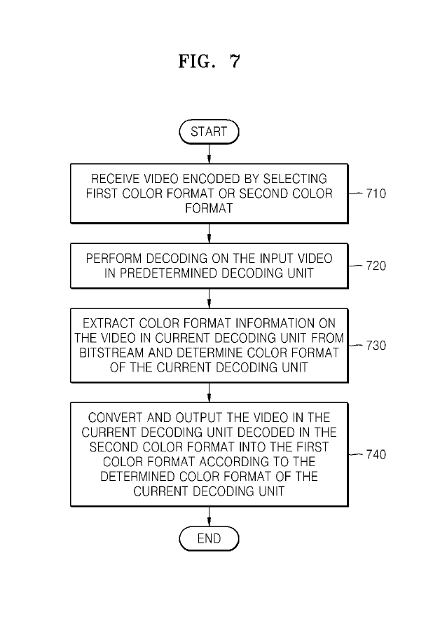

FIG. 7 is a flowchart of a variable color format based video decoding method according to another embodiment of the present invention.

Referring to FIG. 7, in operation 710, a first color format or a second color format is variably selected as a predetermined encoding unit to receive an encoded video. As described above, the first color format may be the RGB color format, and the second color format may be the YCbCr color format.

In operation 720, an input bitstream is decoded in a predetermined decoding unit corresponding to the encoding unit. In operation 730, color format information that is inserted into the bitstream during the encoding operation is extracted per decoding unit to determine a color format used to encode the video of the current decoding unit.

In operation 740, when the current decoding unit is encoded in the first color format, the video of the decoded current encoding unit is output, and when the current decoding unit is encoded in the second color format, the video in the decoded current decoding unit is converted and output into first color format.

Accordingly, corresponding to a channel environment having a variable bit-rate, a video having a uniform quality can be provided.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The invention can also be embodied as computer readable codes on a computer readable transmission medium. An example of the computer readable transmission medium is carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A variable color format based video encoding method comprising:
determining whether or not to perform color format conversion converting an input video in a current encoding unit of a first color format into a second color format by using at least one of channel state information and a result of encoding a video in a predetermined encoding unit encoded in advance;
when the video in the current encoding unit is determined to be converted into the second color format, converting and outputting the video in the current encoding unit of the first color format into the second color format, and otherwise, outputting the video of the current encoding unit in the first color format without changing the color format; and
encoding the output video in the current encoding unit.

2. The method of claim 1, wherein the first color format is an RGB (red, green, blue) color format, and the second color format is a YCbCr color format.

3. The method of claim 1, wherein the predetermined encoding unit is one of a sequence, a frame, a slice, and a macroblock.

4. The method of claim 1,
wherein the channel state information is a bit-rate of a channel, and
wherein in determining the color format conversion, when the bit-rate of the channel is equal to or less than a predetermined first threshold, the video in the current encoding unit of the first color format is converted into the second color format.

5. The method of claim 1, wherein the result of encoding the video in the predetermined encoding unit encoded in advance includes at least one of a quantization parameter generated in the predetermined encoding unit encoded in advance, bit-rate information, and prediction error information.

6. The method of claim 5, wherein in the determining whether or not to perform the color format conversion, when the quantization parameter generated in the predetermined encoding unit encoded in advance is equal to or larger than a predetermined second threshold, the video in the current encoding unit of the first color format is converted into the second color format.

7. The method of claim 5, wherein, when the bit-rate generated in the predetermined encoding unit encoded in advance is equal to or larger than a predetermined third threshold, the video in the current encoding unit of the first color format is converted into the second color format.

8. The method of claim 5, wherein, when the prediction error information generated in the predetermined encoding unit encoded in advance is equal to or larger than a predetermined fourth threshold, the video in the current encoding unit of the first color format is converted into the second color format.

9. The method of claim 1, wherein the encoding the output video further comprises inserting information on a color format of the current encoding unit into a predetermined region of a bitstream generated as a result of the encoding.

10. A variable color format based video encoding apparatus comprising:
a color format determiner which determines whether or not to perform a color format conversion converting an input video in a current encoding unit of a first color format into a second color format by using at least one of channel state information and a result of encoding a video in a predetermined encoding unit encoded in advance, and outputting a predetermined color format control signal representing whether or not to perform the color format conversion;
a color format converter, which, when the video in the current encoding unit is determined to be converted into the second color format according to the color format control signal, converts and outputs the video in the current encoding unit of the first color format into the second color format, and when the color format control signal does not represent the color format conversion, outputs the video of the current encoding unit in the first color format without changing the color format; and
an encoder which encodes the output video in the current encoding unit.

11. The apparatus of claim 10, wherein the first color format is an RGB color format, and the second color format is a YCbCr color format.

12. The apparatus of claim 10, wherein the predetermined encoding unit is one of a sequence, a frame, a slice, and a macroblock.

13. The apparatus of claim 10,
wherein the channel state information is a bit-rate of a channel, and
wherein the color format determiner converts the video in the current encoding unit of the first color format into the second color format when the bit-rate of the channel is equal to or less than a predetermined first threshold.

14. The apparatus of claim 10, wherein the result of encoding the video in the predetermined encoding unit encoded in advance includes at least one of a quantization parameter generated in the predetermined encoding unit encoded in advance, bit-rate information, and prediction error information.

15. The apparatus of claim 14, wherein the color format determiner converts the video in the current encoding unit of the first color format into the second color format when the quantization parameter generated in the predetermined encoding unit encoded in advance is equal to or larger than a predetermined second threshold.

16. The apparatus of claim 14, wherein the color format determiner converts the video in the current encoding unit of the first color format into the second color format when the bit-rate generated in the predetermined encoding unit encoded in advance is equal to or larger than a predetermined third threshold.

17. The apparatus of claim 14, wherein the color format determiner converts the video in the current encoding unit of the first color format is converted into the second color format when the prediction error information generated in the predetermined encoding unit encoded in advance is equal to or larger than a predetermined fourth threshold.

18. The apparatus of claim 10, wherein the encoder inserts information on a color format of the current encoding unit into a predetermined region of a bitstream generated as a result of the encoding.

19. A variable color format based video decoding method comprising:
receiving a video encoded by variably selecting a first color format or a second color format in a predetermined encoding unit;
decoding the input video in a predetermined decoding unit corresponding to the encoding unit;
determining a color format used to encode the video of the current decoding unit by extracting color format information on the video in the current decoding unit from an input bitstream; and
when the current decoding unit is encoded in the first color format, outputting the decoded video of the current decoding unit video without changing the color format, and when the current decoding unit is encoded in the second color format, converting the decoded video of the current decoding unit into the first color format.

20. The method of claim 19, wherein the first color format is an RGB color format, and the second color format is a YCbCr color format.

21. The method of claim 19, wherein the predetermined encoding unit is one of a sequence, a frame, a slice, and a macroblock.

22. A variable color format based video decoding apparatus comprising:
a decoder which receives a video encoded by variably selecting a first color format or a second color format in a predetermined encoding unit and decoding the input video in a predetermined decoding unit corresponding to the encoding unit; and
a color format converter which extracts color format information on the video in the current decoding unit from an input bitstream, when the current decoding unit is encoded in the first color format, outputs the decoded video of the current decoding unit without changing the color format, and when the current decoding unit is encoded in the second color format, converts the decoded video of the current decoding unit into the first color format.

23. The apparatus of claim 22, wherein the first color format is an RGB color format, and the second color format is a YCbCr color format.

24. The apparatus of claim 22, wherein the predetermined encoding unit is one of a sequence, a frame, a slice, and a macroblock.
